(19) United States
(12) Patent Application Publication
(10) Pub. No.: US 2019/0012649 A1
(43) Pub. Date: Jan. 10, 2019

(54) SYSTEM FOR CONNECTING WEB POS SYSTEM WITH PERIPHERAL DEVICE

(71) Applicant: TRUSTED SOLUTIONS CORPORATION, NEW TAIPEI CITY (TW)

(72) Inventor: KUANG HUNG CHENG, NEW TAIPEI CITY (TW)

(21) Appl. No.: 15/645,570

(22) Filed: Jul. 10, 2017

(51) Int. Cl. G06Q 20/20; H04L 29/08; G06F 13/10

(52) U.S. Cl. CPC G06Q 20/202; H04L 67/02; G06F 13/102; H04L 67/42; G06Q 20/208; H04L 67/10; G06Q 20/204

(57) ABSTRACT

A system for connecting a web POS (Point of Sale) system or a smart retailer system with a peripheral device is provided. Through a service software running in an operating system, a browser can transmit a relevant control instruction to the service software in a manner of conforming to the WebSocket protocol. After the service software reassembles a control instruction, the service software connects and controls the peripheral device through a connection interface corresponding to the peripheral device, so that any device can use the browser to execute the web POS system and control various peripheral devices to increase the convenience for the application of the web POS system.

### FIELD OF THE INVENTION

The present invention relates to a system that enables a web POS (Point of Sale) system to connect and operate a peripheral device with ease.

### BACKGROUND OF THE INVENTION

In order to enhance operational efficiency and reduce the probability of human errors, the process managements of most restaurants, catering services, supermarkets, logistics industry and other industry are electronized as the main trend of development. Through reliable information management equipment and program applications, the cost can be reduced and the management is effective, thereby improving the efficiency of the process managements of enterprises. Thus, how to effectively use the advantages of speediness and low error rate of electronization and information is a major topic for the management, and the use of a terminal sales system becomes the key point of success and failure.

For the user of a POS (Point of Sale) software system program 92, as shown in FIG. 1, a host hardware 91 having the POS software system program 92 and a peripheral device 94, such as a barcode scanner, a credit card reader, a printer, and the like, related to the POS software system program 92 are required. The POS software system program 92 stores the relevant data in a cloud server 93. But, for a web POS system, since the browser cannot directly control the peripheral device 94, such as a bar code scanner, a credit card reader, etc., so it is difficult to operate these peripheral devices on a web page.

Therefore, how to overcome the shortcomings of the web POS system is a topic for the industry to improve the web POS system.

Accordingly, the inventor of the present invention has devoted himself based on his many years of practical experiences to solve these problems and develop a system for a web POS system to connect and operate these peripheral devices with ease, effectively increasing the efficiency and flexibility of using the web POS system.

### SUMMARY OF THE INVENTION

The primary object of the present invention is to provide a system for connecting a web POS (Point of Sale) system or a smart retailer system with a peripheral device is provided. Through a service software running in an operating system, a browser can transmit a relevant control instruction to the service software in a manner of conforming to the WebSocket protocol. After the service software reassembles a control instruction, the service software connects and controls the peripheral device through a connection interface of the host corresponding to the peripheral device, so that any device can use the browser to execute the web POS system and control various peripheral devices to increase the convenience for the application of the web POS system.

In order to achieve the aforesaid object, the system of the present invention comprises a host, at least a peripheral device, and a cloud server. The host includes a browser, a network device, and a service software. The browser and the service software are able to execute real-time two-way message transfer in a manner of conforming to the WebSocket protocol. The peripheral device is coupled with the host through a connection interface of the host corresponding to the peripheral device in a wired or wireless manner. The peripheral device and the service software are able to execute two-way message transfer. The cloud server is provided with a web-based web POS system. The host is communicated with the cloud server via the network device. The browser of the host serves as an interface to operate and execute the web POS system of the cloud server. When the service software receives a first instruction that conforms to the WebSocket protocol to operate the peripheral device after the browser executes the web POS system, the service software reassembles the first instruction as a second instruction that has a same operation content as the first instruction and is able to drive the peripheral device, and the second instruction controls the peripheral device through the connection interface corresponding to the peripheral device. When the service software receives a first message from the peripheral device, the service software reassembles the first message as a second message that has a same message content as the first message and conforms to the WebSocket protocol, and the second message is displayed on the browser, and the second message is transmitted to the web POS system. Thereby, the web POS system is able to connect and control the peripheral device.

Preferably, the browser of the host operates and executes the web POS system of the cloud server and immediately stores input data, output data and an operation result in the cloud server.

Preferably, the host is one of a desktop computer, a notebook computer, a tablet computer, and a mobile phone.

Preferably, the peripheral device is one of a printer, a bar code scanner, a magnetic card reader, a credit card reader, a cash drawer, an invoice machinery, a screen, a keyboard and a stylus, or a combination thereof.

### BRIEF DESCRIPTION OF THE DRAWINGS

FIG. 1 is a block diagram of a conventional POS system; and

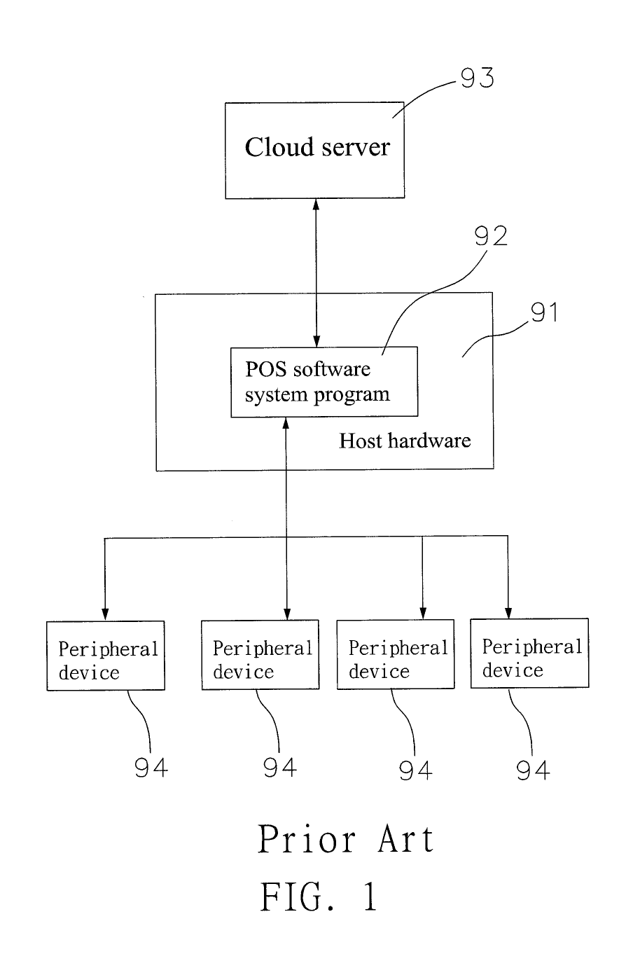

FIG. 2 is a block diagram of a system of the present invention.

### DESCRIPTION OF THE PREFERRED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein.

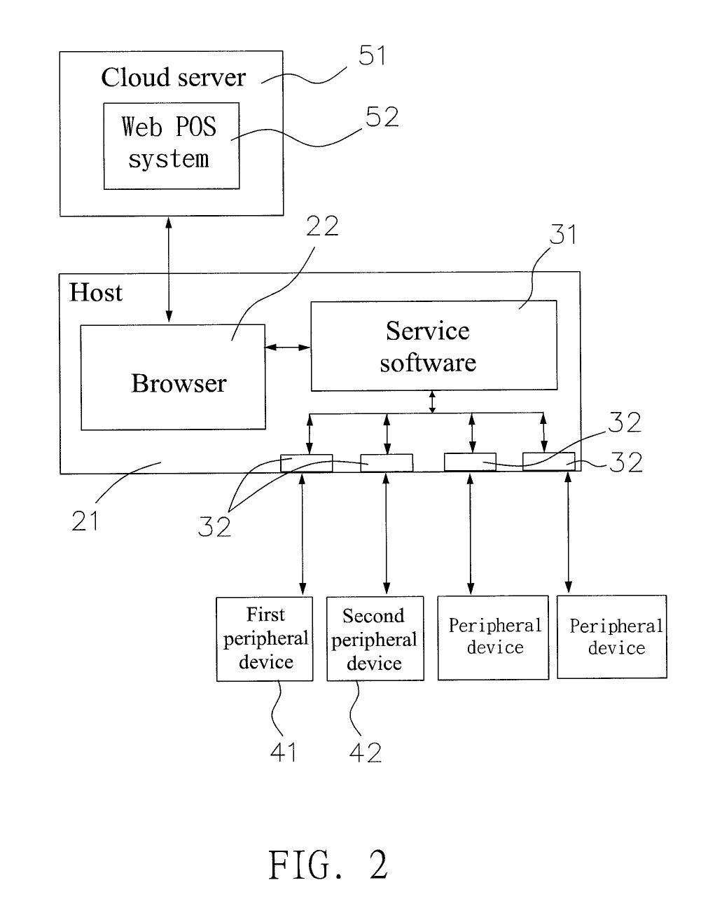

FIG. 2 illustrates a system for connecting a web POS (Point of Sale) system with a peripheral device of the present invention. The system comprises a host 21, at least a peripheral device, and a cloud server 51.

The host 21 includes a browser 22, a network device, and a service software 31. The browser 22 and the service software 31 are able to execute real-time two-way message transfer in a manner of conforming to WebSocket protocol.

The peripheral device is coupled with the host 21 through a connection interface 32 of the host corresponding to the peripheral device in a wired or wireless manner. The peripheral device and the service software 31 are able to execute two-way message transfer. This embodiment includes a plurality of peripheral devices as an illustration. As shown in FIG. 2, the plurality of peripheral devices includes a first peripheral device 41, a second peripheral device 42, and the like.

The cloud server 51 is provided with a web-based web POS system 52. The host 21 is communicated with the cloud server 51 via the network device (not shown). The browser 22 of the host 21 serves as an interface to operate and execute the web POS system 52 of the cloud server 51.

When the service software 31 receives a first instruction that conforms to the WebSocket protocol to operate the first peripheral device 41 after the browser 22 executes the web POS system 52, the service software 31 reassembles the first instruction as a second instruction that has the same operation content as the first instruction and is able to drive the first peripheral device 41. The second instruction controls the first peripheral device through the connection interface 32 corresponding to the first peripheral device 41.

When the service software 31 receives a first message from a second peripheral device 42, the service software 31 reassembles the first message as a second message that has the same message content as the first message and conforms to the WebSocket protocol. The second message is displayed on the browser 22, and the second message is transmitted to the web POS system 52.

Accordingly, the web POS system 52 can connect and control the peripheral devices.

The foregoing web POS system 52 is a software written in a web language. The web language is a program language, such as HTML, JavaScript, Java, and the like. An application written in this web language is operated and executed with a browser 22 as an interface. It is not limited by an operating system, that is, it can be executed by Windows, Mac, Linux, iOS and other operating systems to achieve the use of a cross-platform.

The foregoing host 21 may be a desktop computer, a notebook computer, a tablet computer, a mobile phone, or any host for operating the conventional PUS system, which is able to execute the operation of the browser 22.

The foregoing web POS system 52 executes the operations, such as, sales, cash register, printing invoices and receipts, and so on, and provides inventory schedules of retail stores/sales counters/franchise stores, daily sales schedules of retail stores/sales counters, sales statistics of members, commodity daily sales statistics of retail stores/sales counters, monthly sales statistics of retail stores/sales counters, time interval sales statistics, sales statistics of commodity time interval. The aforesaid is only an example. The actual functions of the web POS system 52 are not limited to the aforesaid.

As to the web page POS system 52, the user can click the link point of the web POS system 52 from the browser 22 of the host 21, that is, the browser 22 serves as an interface to execute all the functions of the web POS system 52. The user does not need to download the software of the POS system, does not need to install the POS system, and does not need to upgrade and update the web POS system 52. It is very simple for the user to use the system. There will be no burden of maintenance.

The first peripheral device 41 may be one of a printer, a bar code scanner, a magnetic card reader, a credit card reader, a cash drawer, an invoice machinery, a screen, a keyboard and a stylus or a combination thereof, but not limited to the aforesaid.

The browser 22 of the host 21 can operate and execute the web POS system 52 of the cloud server 51 and immediately store input data, output data and the result of the operation in the cloud server. This way not only reduces the hardware condition and the operational load of the host 21 but also forms big data through the data stored in the cloud server 51, including sales data of each region, each store, each time interval and various customer preferences. In addition, the big data can be further analyzed and compiled to get valuable trend information.

The web-based software has the advantage of a cross-platform operating system. The POS system needs to use a variety of peripheral equipment, such as a bar code scanner, a magnetic card reader, a credit card reader, a cash drawer, an invoice machinery, etc. The web software operated on the browser is unable to directly control the peripheral equipment connected with the host in which the browser is located, so most of the existing POS systems are an application software directly executed in the operating system, with various driven programs of the operating system to control the corresponding peripheral equipment. Such an implementation of the POS system doesn't have the advantage of a cross-platform operating system.

The present invention is provided with the service software 31 to solve the above problems. The browser 22 and the service software 31 are able to execute real-time two-way message transfer in a manner of conforming to the WebSocket protocol. The WebSocket protocol is a protocol for full-duplex communication over a single TCP connection. WebSocket makes it easier to exchange data between the client and the server. In the WebSocket API, the browser and the server only need to complete a handshaking to directly establish a continuous connection and two-way data transfer. By using the characteristics of the WebSocket protocol, the browser 22 and the service software 31 of the present invention are able to execute real-time two-way message transfer in a manner of conforming to the WebSocket protocol.

When the user executes the web POS system 52, if it is necessary to operate a peripheral device, for example, a bar code scanner to scan a commodity, the browser 22 will transmit a first instruction that conforms to the WebSocket protocol to operate the peripheral device (such as, a bar code scanner) to the service software 31. When the service software 31 receives the first instruction that conforms to the WebSocket protocol to operate the peripheral device after the browser 22 executes the web POS system 52, the service software 31 reassembles the first instruction as a second instruction that has the same operation content (such as, scanning the commodity) as the first instruction and is able to drive the first peripheral device 41. The second instruction operates the first peripheral device through the connection interface 32 (such as, a USB port) corresponding to the first peripheral device 41 (such as, a bar code reader), such that the web POS system 52 can control the peripheral device by the browser 22.

On the other hand, after the operation of the peripheral device is completed, the peripheral device returns the result message to the web PUS system 52. The system of the present invention is described hereinafter. The peripheral device (such as, a bar code scanner) returns the execution result (such as, a bar code message) to the service software 31, that is, when the service software 31 receives a first message (such as, a bar code message) from a second peripheral device 42 (such as, a bar code scanner), the service software 31 reassembles the first message as a second message (such as, a bar code message) that has the same message content as the first message and conforms to the WebSocket protocol. The second message is displayed on the browser 22 and the second message is transmitted to the web POS system 52, such that the web POS system 52 can detect the execution result of the peripheral device by the browser 22.

From the above description, the system of the present invention has the advantage that the service software 31 of the operating system allows the browser 22 to transmit the relevant control instruction to the service software 31 in a manner conforming to the WebSocket protocol. After the service software 31 reassembles the control instruction, the service software 3 controls the peripheral device (such as a printer, a bar code scanner) through the connection interface 32 (such as, USB, RS-232) corresponding to the peripheral device, so that any device can use the browser 22 to control the web POS system 52.

The system of the present invention solves the problem of the prior art that the browser executing the web POS system cannot control the peripheral device, greatly increasing the convenience of the application of the web POS system.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A system for connecting a web POS (Point of Sale) system with a peripheral device, comprising:
a host, including a browser, a network device, and a service software, the browser and the service software being able to execute real-time two-way message transfer in a manner of conforming to WebSocket protocol;
at least a peripheral device, coupled with the host through a connection interface of the host corresponding to the peripheral device in a wired or wireless manner, the peripheral device and the service software being able to execute two-way message transfer;
a cloud server, provided with a web-based web POS system, the host being communicated with the cloud server via the network device, the browser of the host serving as an interface to operate and execute the web POS system of the cloud server;
wherein when the service software receives a first instruction that conforms to the WebSocket protocol to operate the peripheral device after the browser executes the web POS system, the service software reassembles the first instruction as a second instruction that has a same operation content as the first instruction and is able to drive the peripheral device, and the second instruction controls the peripheral device through the connection interface corresponding to the peripheral device;
wherein when the service software receives a first message from the peripheral device, the service software reassembles the first message as a second message that has a same message content as the first message and conforms to the WebSocket protocol, and the second message is displayed on the browser, and the second message is transmitted to the web POS system;
thereby, enabling the web POS system to connect and control the peripheral device.

2. The system as claimed in claim 1, wherein the browser of the host operates and executes the web POS system of the cloud server and immediately stores input data, output data and an operation result in the cloud server.

3. The system as claimed in claim 1, wherein the host is one of a desktop computer, a notebook computer, a tablet computer, and a mobile phone.

4. The system as claimed in claim 1, wherein the peripheral device is one of a printer, a bar code scanner, a magnetic card reader, a credit card reader, a cash drawer, an invoice machinery, a screen, a keyboard and a stylus, or a combination thereof.
